(19) United States
(12) Patent Application Publication
(10) Pub. No.: US 2026/0270374 A1
(43) Pub. Date: Sep. 10, 2026

(54) INFORMATION PROCESSING APPARATUS, OUTDOOR UNIT OF INTERCOM SYSTEM, INFORMATION PROCESSING METHOD, AND PROGRAM

(71) Applicant: Yokogawa Electric Corporation, Musashino-shi, Tokyo (JP)

(72) Inventors: Atsushi WADA, Musashino-shi, Tokyo (JP); Osamu KOJIMA, Musashino-shi, Tokyo (JP)

(73) Assignee: Yokogawa Electric Corporation, Musashino-shi, Tokyo (JP)

(21) Appl. No.: 19/165,830

(22) PCT Filed: Feb. 15, 2024
(86) PCT No.: PCT/JP2024/005346

§ 371 Date: Sep. 16, 2025

(30) Foreign Application Priority Data
Mar. 23, 2023 (JP) 2023-047349

(51) Int. Cl. H04N 7/18; G06V 10/82; G06V 20/52; G06V 40/16

(52) U.S. Cl. CPC H04N 7/186; G06V 10/82; G06V 20/52; G06V 40/161

(57) ABSTRACT

An information processing apparatus includes a controller that acquires an image captured using an imager included in an outdoor device of an intercom system and executes a process to notify a user according to one or more of clothing information, included in the acquired image, for a visitor and unattended delivery information, included in the acquired image, for a delivery item delivered by the visitor.

### CROSS-REFERENCE TO RELATED APPLICATION

The present application claims priority to Japanese Patent Application No. 2023-047349 filed on Mar. 23, 2023, the entire contents of which are incorporated herein by reference.

### TECHNICAL FIELD

The present disclosure relates to an information processing apparatus, an outdoor unit of an intercom system, an information processing method, and a program.

### BACKGROUND

Technology related to intercom systems is known. For example, Patent Literature (PTL) 1 discloses an intercom system in which, when a delivery person arrives with a delivery item, a resident can recognize the visitor as a delivery person without having to respond.

### CITATION LIST

### Patent Literature

PTL 1: JP 2022-070683 A

### SUMMARY

### Technical Problem

In conventional intercom systems, it is possible to perform authentication processing based on a visitor's face from an image captured by an imager in the outdoor unit, but processing based on a wider range of information, such as the visitor's clothing and existence of a package placed by unattended delivery, has not been fully considered. This has reduced the convenience for users of intercom systems.

It is an aim of the present disclosure to provide an information processing apparatus, an outdoor unit of an intercom system, an information processing method, and a program that can improve the convenience for the user of an intercom system.

### Solution to Problem

An information processing apparatus according to several embodiments includes a controller configured to acquire an image captured using an imager included in an outdoor unit of an intercom system and execute a process to notify a user according to at least one of clothing information, included in the acquired image, for a visitor and unattended delivery information, included in the acquired image, for a delivery item delivered by the visitor.

This can improve the convenience for the user of the intercom system. The information processing apparatus executes a process to notify the user according to at least one of clothing information for a visitor and unattended delivery information for a delivery item delivered by the visitor. Therefore, the information processing apparatus can execute processing based on a wider range of information, such as the visitor's clothing and existence of a package placed by unattended delivery, as compared to conventional technology that executes processing based only on the visitor's face. As a result, the information processing apparatus can execute more varied detection processing and the like, as will be described using FIG. 3, thereby contributing to improved user convenience.

In the information processing apparatus according to an embodiment, the image acquired by the controller may be captured by a wide-angle camera, included in the imager, having an angle of view including the entire body of the visitor to the ground directly below the outdoor unit.

This enables the information processing apparatus to execute processing based on an image that has an angle of view including the entire body of the visitor to the ground directly below the outdoor unit. Cameras in conventional intercom systems are equipped primarily for the purpose of capturing faces. Therefore, the angle of view of the camera is narrow, causing the range of the captured image to be too small. Consequently, information such as clothing information is not included in the image. For example, conventional cameras generally have an angle of view of 50 to 70 degrees. In contrast, the wide-angle camera included in the imager has a wider angle of view of 120 degrees or more and can capture images with a wide enough range to check the entire body of the visitor and any delivery items placed by unattended delivery.

In an information processing apparatus in an embodiment, the clothing information may include information on a full-body uniform worn by the visitor as a delivery person of a delivery company, and the controller may be configured to detect the visitor as the delivery person by image analysis based on information on the uniform.

This also enables the information processing apparatus to distinguish a delivery person of a delivery company from among various visitors and to execute a specific notification process. For example, the information processing apparatus can notify the user of a visit by a delivery person of a delivery company with a different ringtone than the standard ringtone, thereby making it easier for the user to distinguish the delivery person from other visitors. The user can easily distinguish between the delivery person of a delivery company and other visitors based on the ringtone. The convenience for the user of the intercom system therefore improves.

In the information processing apparatus in an embodiment, the unattended delivery information may include placement of the delivery item on the ground as first information, and the controller may be configured to detect that the delivery item has been placed by unattended delivery by image analysis based on the first information.

This also enables the information processing apparatus to distinguish the unattended delivery of a delivery item from a visit by a visitor and to execute a specific notification process. For example, the information processing apparatus can notify the user of the unattended delivery of a delivery item with a different ringtone than the ringtone for a visit by a visitor, thereby making it easier for the user to distinguish the unattended delivery from a visit by a visitor. The ringtone in this case may, for example, be triggered by an autonomous operation of the controller in the information processing apparatus upon detection of the unattended delivery by the information processing apparatus, rather than by the visitor pressing a call button. The user can recognize that a delivery item was placed by unattended delivery based on the ringtone. The convenience for the user of the intercom system therefore improves.

In the information processing apparatus in an embodiment, the unattended delivery information may include an appearance of the delivery item placed on the ground as second information, and the controller may be configured to detect a type of the delivery item by image analysis based on the second information.

This also enables the information processing apparatus to distinguish the type of the delivery item and to execute a specific notification process for each type. For example, the information processing apparatus can notify the user of a delivery item in a cardboard box with a different ringtone than the ringtone for other types of delivery items, thereby making it easier for the user to distinguish the delivery item from other types of delivery items. The user can easily distinguish between a delivery item in a cardboard box and other types of delivery items based on the ringtone. The convenience for the user of the intercom system therefore improves.

In the information processing apparatus according to an embodiment, the controller may be configured to detect a position of a face of the visitor by image analysis based on the image, enlarge a region containing the face, and cause an indoor unit of the intercom system to display the region.

The information processing apparatus thus makes it easier for the user to identify the visitor's face. The user can easily identify the visitor's face based on the image displayed on the indoor unit. The convenience for the user of the intercom system therefore improves.

In the information processing apparatus in an embodiment, the controller may be configured to execute the image analysis using an application constructed based on machine learning that includes deep learning using a neural network,

As a result, the information processing apparatus can more accurately execute various detection processes using image analysis. Therefore, the information processing apparatus can also more accurately execute the notification process following the detection process. The user can receive more accurate notifications from the intercom system.

An outdoor unit of an intercom system according to several embodiments includes any of the above-described information processing apparatuses.

This can improve the convenience for the user of the intercom system. The information processing apparatus executes a process to notify the user according to at least one of clothing information for a visitor and unattended delivery information for a delivery item delivered by the visitor. Therefore, the information processing apparatus can execute processing based on a wider range of information, such as the visitor's clothing and existence of a package placed by unattended delivery, as compared to conventional technology that executes processing based only on the visitor's face. As a result, the information processing apparatus can execute more varied detection processing and the like, as will be described using FIG. 3, thereby contributing to improved user convenience.

An information processing method according to several embodiments includes acquiring an image captured using an imager included in an outdoor unit of an intercom system, and executing a process to notify a user according to at least one of clothing information, included in the acquired image, for a visitor and unattended delivery information, included in the acquired image, for a delivery item delivered by the visitor.

This can improve the convenience for the user of the intercom system. The information processing apparatus executing the information processing method executes a process to notify the user according to at least one of clothing information for a visitor and unattended delivery information for a delivery item delivered by the visitor. Therefore, the information processing apparatus can execute processing based on a wider range of information, such as the visitor's clothing and existence of a package placed by unattended delivery, as compared to conventional technology that executes processing based only on the visitor's face. As a result, the information processing apparatus can execute more varied detection processing and the like, as will be described using FIG. 3, thereby contributing to improved user convenience.

A program according to several embodiments is configured to cause an information processing apparatus to execute operations including acquiring an image captured using an imager included in an outdoor unit of an intercom system, and executing a process to notify a user according to at least one of clothing information, included in the acquired image, for a visitor and unattended delivery information, included in the acquired image, for a delivery item delivered by the visitor.

This can improve the convenience for the user of the intercom system. The information processing apparatus executes a process to notify the user according to at least one of clothing information for a visitor and unattended delivery information for a delivery item delivered by the visitor. Therefore, the information processing apparatus can execute processing based on a wider range of information, such as the visitor's clothing and existence of a package placed by unattended delivery, as compared to conventional technology that executes processing based only on the visitor's face. As a result, the information processing apparatus can execute more varied detection processing and the like, as will be described using FIG. 3, thereby contributing to improved user convenience.

### Advantageous Effect

According to the present disclosure, an information processing apparatus, an outdoor unit of an intercom system, an information processing method, and a program that can improve the convenience for the user of an intercom system can be provided.

### BRIEF DESCRIPTION OF DRAWINGS

In the accompanying drawings:

FIG. 1 is a configuration diagram illustrating an example configuration of an information processing system according to an embodiment of the present disclosure;

FIG. 2 is a block diagram illustrating an example configuration of each apparatus illustrated in FIG. 1;

FIG. 3 is a sequence diagram illustrating an example of a process executed by the information processing system in FIG. 1; and

FIG. 4 is a schematic diagram illustrating an example of a process executed by the information processing apparatus in FIG. 2.

### DETAILED DESCRIPTION

Embodiments of the present disclosure are mainly described below with reference to the drawings.

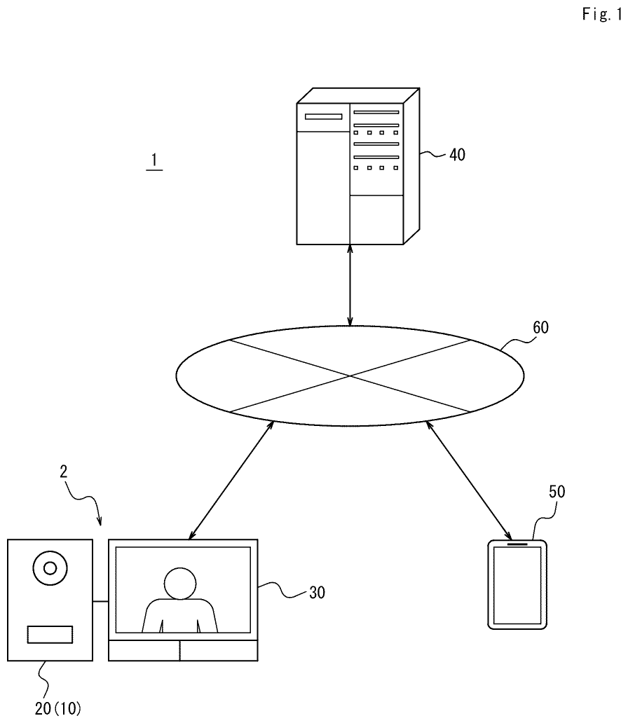

FIG. 1 is a configuration diagram illustrating an example configuration of an information processing system 1 according to an embodiment of the present disclosure. An overview of the information processing system 1 according to an embodiment of the present disclosure is mainly described with reference to FIG. 1. The information processing system 1 includes an intercom system 2, a server apparatus 40, and a terminal apparatus 50. The intercom system 2 includes an information processing apparatus 10, an outdoor unit 20 having the information processing apparatus 10 therein, and an indoor unit 30.

To simplify the explanation, FIG. 1 illustrates only one intercom system 2 having the information processing apparatus 10, but the number of intercom systems 2 that the information processing system 1 has may be two or more. In one intercom system 2, a plurality of one-to-one combinations of an outdoor unit 20 and an indoor unit 30 may be included, a plurality of indoor units 30 may be combined with one outdoor unit 20, and a plurality of outdoor units 20 may be combined with one indoor unit 30. In accordance with the number of outdoor units 20, the number of information processing apparatuses 10 may be two or more. At least one information processing apparatus 10 is arranged in one outdoor unit 20.

To simplify the explanation, FIG. 1 illustrates only one server apparatus 40, but the number of server apparatuses 40 in the information processing system 1 may be two or more. Similarly, although only one terminal apparatus 50 is illustrated in the drawings, the number of terminal apparatuses 50 in the information processing system 1 may be two or more.

Each of the information processing apparatus 10 included in the outdoor unit 20, the indoor unit 30, the server apparatus 40, and the terminal apparatus 50 is communicably connected to a network 60 that includes a mobile communication network, the Internet, and the like.

As an overview of one embodiment, the information processing apparatus 10 acquires images captured using an imager 21, described below, that is included in the outdoor unit 20 of the intercom system 2. Unlike conventional intercom systems in which a camera starts capturing images after a visitor presses a call button, the information processing apparatus 10 may continuously capture images with the imager 21 of the outdoor unit 20 and continuously acquire the images.

In the present disclosure, the “images” include still and moving images. The images include, for example, an image captured by a wide-angle camera, included in the imager 21, having an angle of view including the entire body of the visitor to the ground directly below the outdoor unit 20.

In the present disclosure, the “visitor” includes a person who has visited a residence, occupied by a resident as the user, for a predetermined purpose. Visitors include a delivery person of a delivery company who has visited the residence for the purpose of delivering a delivery item, a salesman who has visited the residence for sales purposes, and an acquaintance of the user who has visited the residence for the purpose of communicating with the user. In the present disclosure, the “residence” includes a residence equipped with the intercom system 2, such as a single-family home and an apartment complex.

The information processing apparatus 10 executes a process to notify the user as the resident according to at least one of clothing information, included in the acquired image, for a visitor and unattended delivery information, included in the acquired image, for a delivery item delivered by the visitor.

In the present disclosure, the “clothing information” includes information about the clothing worn by the visitor. The clothing information includes information on a full-body uniform worn by a delivery person of a delivery company, information on a full-body suit worn by a salesman, information on full-body plainclothes worn by an acquaintance of the user, and the like. The “delivery item” includes cardboard boxes containing any items to be sent to the user, cases containing books, documents, or the like, containers covered with thermal sheeting and containing food to be delivered by unattended delivery, and the like.

In the present disclosure, the “unattended delivery information” includes, for example, placement of the delivery item on the ground directly below the outdoor unit 20 as first information, and the appearance of the delivery item placed on the ground as second information. The “unattended delivery” means, for example, that the delivery item is placed by the delivery person at a predetermined location, such as the entrance, when the user as the recipient of the delivery cannot receive the delivery item in person for reasons such as not being at home.

In the present disclosure, the “notification process” includes, for example, a process by which the outdoor unit 20 that has the information processing apparatus 10 provides notification of at least one of the fact that a visitor has arrived and that a delivery item has been placed by unattended delivery. The notification process is performed with respect to at least one of the indoor unit 30 and the terminal apparatus 50. For example, the outdoor unit 20 may execute the notification process by a method such as by e-mail or other messaging functions via the network 60, with respect to the terminal apparatus 50 used by a user residing as a resident in the residence in which the intercom system 2 is installed. The notification process includes, for example, output that acts on at least one of the auditory and visual senses of the user as a resident. The output may include output of ringtones, such as chimes, buzzers, bells, and melodies, output of images of the visitor, the delivery item that was placed by unattended delivery, and the like, and visual and auditory output of messages indicating the visitor, the delivery item that was placed by unattended delivery, and the like. The ringtone includes, for example, a sound triggered by an input operation by the visitor using an input interface 22 of the outdoor unit 20, such as the visitor pressing a call button, as described below.

The information processing apparatus 10 includes an apparatus that controls the operations of the outdoor unit 20 while mounted in the outdoor unit 20 of the intercom system 2 installed in the user's residence. The information processing apparatus 10 acquires images as necessary information in the outdoor unit 20 and executes a notification process as an operation of the outdoor unit 20 with respect to at least one of the indoor unit 30 and the terminal apparatus 50.

The outdoor unit 20 includes an apparatus that is provided in the user's residence as part of the intercom system 2. The outdoor unit 20 includes, for example, an apparatus that is provided at the front door of a single-family home or at the entrance of an apartment complex in which the user resides as a resident. This apparatus is used by a visitor to inform the user of the visitor's presence.

The indoor unit 30 includes an apparatus that is provided in the user's residence as part of the intercom system 2. The indoor unit 30 includes, for example, an apparatus that is installed in the living room of a single-family home or in the living room of an apartment complex where the user resides as a resident. This apparatus is used in con-junction with the outdoor unit 20 to notify the user that a visitor has arrived.

The server apparatus 40 includes one apparatus or a plurality of apparatuses that can communicate with one another. The server apparatus 40 may include any general purpose electronic device, such as a personal computer (PC) and a smartphone, or may include another electronic device dedicated to the information processing system 1. The server apparatus 40 is managed by a business or the like that provides the user with a service of image-based notification using the intercom system 2.

The terminal apparatus 50 includes general purpose electronic devices such as smartphones, smartwatches and other wearable devices, PCs, and tablet PCs. The terminal apparatus 50 is an electronic device used by a user residing as a resident in a residence in which the intercom system 2 is installed. The terminal apparatus 50 is not limited to these examples and may include one server apparatus, or a plurality of server apparatuses that can communicate with each other, used by the user, and may also include other electronic devices dedicated to the information processing system 1.

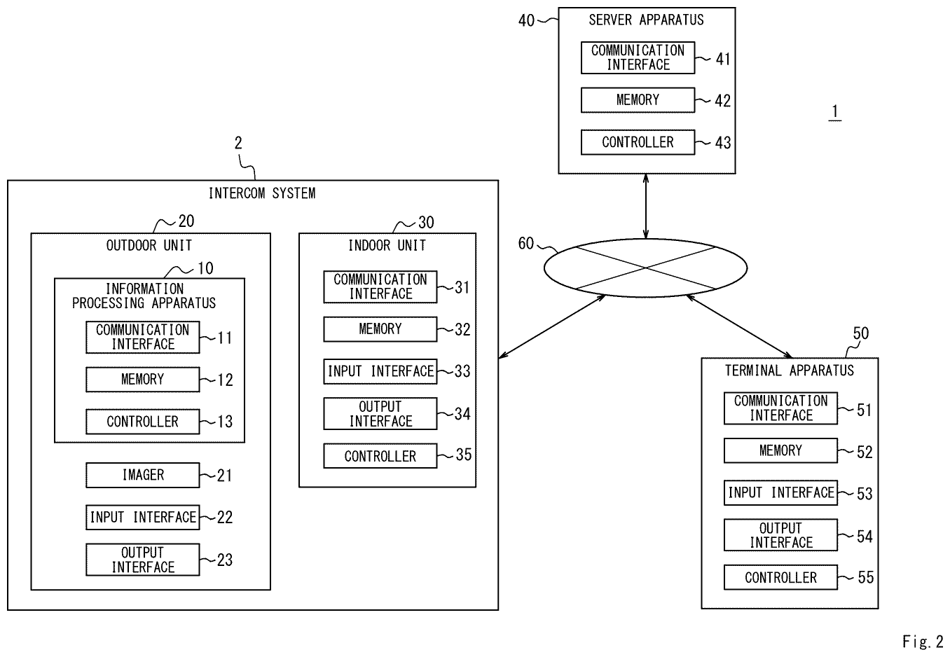

FIG. 2 is a block diagram illustrating an example configuration of each apparatus illustrated in FIG. 1. With reference to FIG. 2, respective example configurations of the information processing apparatus 10, the outdoor unit 20, the indoor unit 30, the server apparatus 40, and the terminal apparatus 50 included in the information processing system 1 are mainly described.

As illustrated in FIG. 2, the information processing apparatus 10 provided in the outdoor unit 20 includes a communication interface 11, a memory 12, and a controller 13.

The communication interface 11 includes one or more communication interfaces. The communication interfaces can connect to the network 60. The communication interfaces support, for example, mobile communication standards such as 4G (4th Generation) and 5G (5th Generation), wired LAN (Local Area Network) standards, or wireless LAN standards, but are not limited to these examples and may support any communication standards. In addition, the communication interfaces also support pre-determined communication standards that enable connection and communication between the outdoor unit 20 and the indoor unit 30. In an embodiment, the information processing apparatus 10 is communicably connected to the network 60 and the indoor unit 30 via the communication interface 11.

The memory 12 includes a memory apparatus such as a Hard Disk Drive (HDD), Solid State Drive (SSD), Electrically Erasable Programmable Read-Only Memory (EEPROM), Read-Only Memory (ROM), and Random Access Memory (RAM). The memory 12 stores information necessary to realize the operations of the information processing apparatus 10. Information acquired by operations of the information processing apparatus 10 is stored in the memory 12. For example, the memory 12 stores system programs, application programs, and various data acquired by any means such as communication.

The memory 12 may function as a main memory, an auxiliary memory, or a cache memory. The memory 12 is not limited to being internal to the information processing apparatus 10 and may include an external memory apparatus connected through a digital input/output port or the like, such as universal serial bus (USB).

The controller 13 includes one or more processors. In the present disclosure, the “processor” is a general purpose processor or a dedicated processor specialized for particular processing, but these examples are not limiting. The controller 13 is communicably connected with each component of the information processing apparatus 10 and controls operations of the information processing apparatus 10 overall.

The configuration of the outdoor unit 20 in the intercom system 2 included in the information processing system 1 will be mainly described. As illustrated in FIG. 2, the outdoor unit 20 includes the information processing apparatus 10, the imager 21, the input interface 22, and an output interface 23.

The imager 21 includes a wide-angle camera having an angle of view including the entire body of the visitor to the ground directly below the outdoor unit 20. The wide-angle camera has an angle of view of 120 degrees or more, for example. The imager 21 captures an image including at least one of clothing information for a visitor and unattended delivery information for a delivery item delivered by the visitor and outputs the image to the controller 13 of the information processing apparatus 10.

The input interface 22 includes one or more input interfaces that accept input operations by the visitor when the visitor wishes to communicate his or her visit to the user. The input interfaces include a call button, physical and capacitive keys for entering the user's room number in a housing complex, a microphone that accepts the visitor's voice input, and the like.

The output interface 23 includes one or more output interfaces that output, to the visitor, the user's response to an input operation by the visitor using the input interface 22. The output interface includes a speaker or the like that outputs the response from the user as audio.

The configuration of the indoor unit 30 in the intercom system 2 included in the information processing system 1 will be mainly described. As illustrated in FIG. 2, the indoor unit 30 includes a communication interface 31, a memory 32, an input interface 33, an output interface 34, and a controller 35.

The communication interface 31 includes one or more communication interfaces. The communication interfaces can connect to the network 60. The communication interfaces support, for example, mobile communication standards such as 4G and 5G, wired LAN standards, or wireless LAN standards, but are not limited to these examples and may support any communication standards. In addition, the communication interfaces also support predetermined communication standards that enable connection and communication between the indoor unit 30 and the outdoor unit 20. In an embodiment, the indoor unit 30 is communicably connected to the network 60 and the outdoor unit 20 via the communication interface 31.

The memory 32 includes a memory apparatus such as an HDD, SSD, EEPROM, ROM, or RAM. The memory 32 stores information necessary to realize the operations of the indoor unit 30. Information acquired by operations of the indoor unit 30 is stored in the memory 32. For example, the memory 32 stores system programs, application programs, and various data acquired by any means such as communication.

The memory 32 may function as a main memory, an auxiliary memory, or a cache memory. The memory 32 is not limited to being internal to the indoor unit 30 and may include an external memory apparatus connected through a digital input/output port or the like, such as USB.

The input interface 33 includes one or more interfaces for input to detect user input and acquire input information based on user operations. The input interface may be a physical key, a capacitive key, a touchscreen provided integrally with a display of the output interface 34, a microphone that receives audio input, or the like.

The output interface 34 includes one or more interfaces for output to output information and notify the user. The output interfaces include a display that outputs information as images, a speaker that outputs information as sound, and the like.

The controller 35 includes one or more processors. The controller 35 is communicably connected with each component of the indoor unit 30 and controls overall operations of the indoor unit 30.

Next, the configuration of the server apparatus 40 included in the information processing system 1 will be mainly described. As illustrated in FIG. 2, the server apparatus 40 includes a communication interface 41, a memory 42, and a controller 43.

The communication interface 41 includes one or more communication interfaces that connect to the network 60. The communication interfaces support, for example, mobile communication standards such as 4G and 5G, wired LAN standards, or wireless LAN standards, but are not limited to these examples and may support any communication standards. In an embodiment, the server apparatus 40 is communicably connected to the network 60 via the communication interface 41. The communication interface 41 transmits and receives various information via the network 60.

The memory 42 includes a memory apparatus such as an HDD, SSD, EEPROM, ROM, or RAM. The memory 42 stores information necessary to realize the operations of the server apparatus 40. Information acquired by operations of the server apparatus 40 is stored in the memory 42. For example, the memory 42 stores system programs, application programs, and various data acquired by any means such as communication.

The memory 42 may function as a main memory, an auxiliary memory, or a cache memory. The memory 42 is not limited to being internal to the server apparatus 40 and may include an external memory apparatus connected through a digital input/output port or the like, such as USB.

The controller 43 includes one or more processors. The controller 43 is communicably connected with each component of the server apparatus 40 and controls operations of the server apparatus 40 overall.

The configuration of the terminal apparatus 50 included in the information processing system 1 will be mainly described. As illustrated in FIG. 2, the terminal apparatus 50 includes a communication interface 51, a memory 52, an input interface 53, an output interface 54, and a controller 55.

The communication interface 51 includes one or more communication interfaces that connect to the network 60. The communication interfaces support, for example, mobile communication standards such as 4G and 5G, wired LAN standards, or wireless LAN standards, but are not limited to these examples and may support any communication standards. In an embodiment, the terminal apparatus 50 is communicably connected to the network 60 via the communication interface 51. The communication interface 51 transmits and receives various information via the network 60.

The memory 52 includes a memory apparatus such as an HDD, SSD, EEPROM, ROM, or RAM. The memory 52 stores information necessary to realize the operations of the terminal apparatus 50. Information acquired by operations of the terminal apparatus 50 is stored in the memory 52. For example, the memory 52 stores system programs, application programs, and various data acquired by any means such as communication.

The memory 52 may function as a main memory, an auxiliary memory, or a cache memory. The memory 52 is not limited to being internal to the terminal apparatus 50 and may include an external memory apparatus connected through a digital input/ output port or the like, such as USB.

The input interface 53 includes one or more interfaces for input to detect user input and acquire input information based on user operations. The input interface may be a physical key, a capacitive key, a touchscreen provided integrally with a display of the output interface 54, an imaging module such as a camera, a microphone that receives audio input, or the like.

The output interface 54 includes one or more interfaces for output to output information and notify the user. The output interfaces include a display that outputs information as images, a speaker that outputs information as sound, a vibrator that outputs information as vibration, and the like.

The controller 55 includes one or more processors. The controller 55 is communicably connected with each component of the terminal apparatus 50 and controls operations of the terminal apparatus 50 overall.

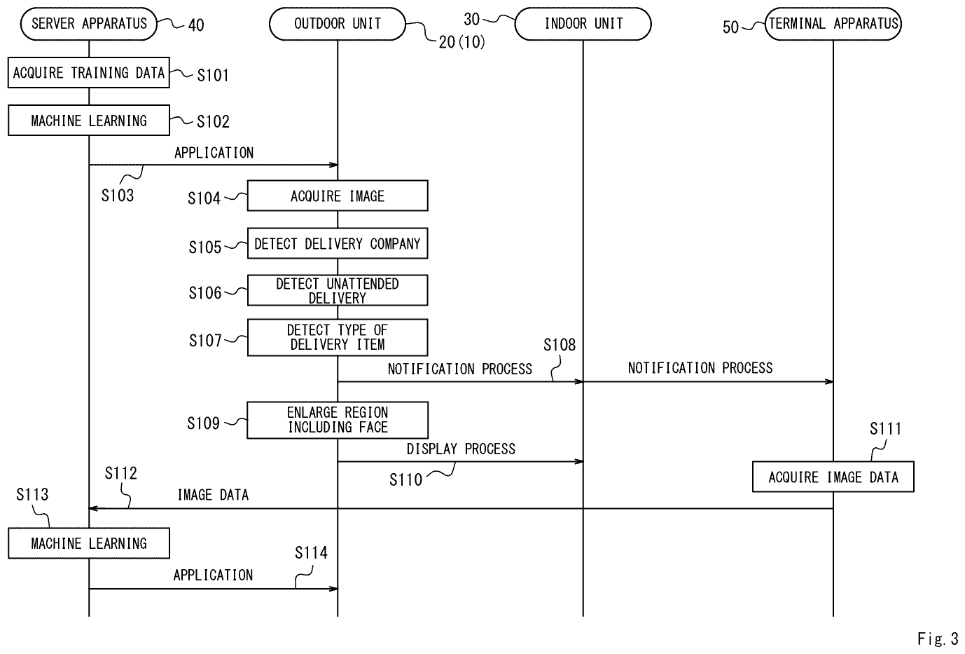

FIG. 3 is a sequence diagram illustrating an example of a process executed by the information processing system 1 of FIG. 1. An example of a method of an information processing method executed by the information processing system 1 in FIG. 1 is mainly described with reference to FIG. 3.

In step S101, the controller 43 of the server apparatus 40 acquires training data. In the present disclosure, “training data” includes data used by the controller 43 to construct, by machine learning, an application to be installed on the outdoor unit 20 of the intercom system 2. The “application” includes software for the outdoor unit 20 to perform the image analysis described below. The training data includes data in which information on the clothing worn by the visitor is associated with the type of visitor, data in which an image of a delivery item placed by unattended delivery is associated with information indicating the existence of an unattended delivery, data in which information on the appearance of the delivery item is associated with the type of delivery item, data in which an image of the visitor is associated with the face of the visitor in the image, and the like.

Such training data is, for example, provided to the server apparatus 40 by the responsible user at the business managing the server apparatus 40. For example, in a case in which a major delivery company that provides services nationwide changes its uniform, the business that manages the server apparatus 40 may receive training data from the major delivery company to identify the new uniform. The training data may then be provided to the server apparatus 40 by the business managing the server apparatus 40. The aforementioned responsible user enters the training data using his or her own terminal apparatus, for example, and the controller 43 receives the training data from the terminal apparatus via the network 60 and the communication interface 41. Although the terminal apparatus is not depicted in FIGS. 1 and 2 to simplify the explanation, the information processing system 1 may, in addition to the intercom system 2, the server apparatus 40, and the terminal apparatus 50, further include the afore-mentioned terminal apparatus used by the responsible user at the business that manages the server apparatus 40.

In step S102, the controller 43 of the server apparatus 40 performs machine learning based on the training data acquired in step S101. In the present disclosure, “machine learning” includes the learning process for the controller 43 to construct the application. Machine learning includes techniques such as deep learning using neural networks.

In step S103, the controller 43 of the server apparatus 40 provides the application constructed by the machine learning process in step S102 to the outdoor unit 20 of the intercom system 2. The controller 43 transmits the application to the outdoor unit 20 via the communication interface 41 and the network 60. The controller 13 of the information processing apparatus 10 included in the outdoor unit 20 downloads the application from the server apparatus 40 via the network 60 and the communication interface 11 and installs the application.

In step S104, the controller 13 of the information processing apparatus 10 acquires an image captured using the imager 21 that is included in the outdoor unit 20 of the intercom system 2. The controller 13 acquires, for example, an image captured by a wide-angle camera, included in the imager 21, having an angle of view including the entire body of the visitor to the ground directly below the outdoor unit 20.

In step S105, if information on a full-body uniform worn by the visitor as a delivery person of a delivery company is included as clothing information in the image acquired in step S104, for example, the controller 13 of the information processing apparatus 10 detects the visitor as a delivery person of the delivery company by image analysis based on the information on the uniform. The image analysis is performed using the application installed on the outdoor unit 20 in step S103.

In step S106, if first information indicating that a delivery item was placed on the ground directly below the outdoor unit 20 is included as unattended delivery information in the image acquired in step S104, for example, the controller 13 of the information processing apparatus 10 detects that a delivery item has been placed by unattended delivery by image analysis based on the first information. The image analysis is performed using the application installed on the outdoor unit 20 in step S103.

In step S107, if second information indicating the appearance of a delivery item placed on the ground directly below the outdoor unit 20 is included as unattended delivery information in the image acquired in step S104, for example, the controller 13 of the information processing apparatus 10 detects the type of delivery item by image analysis based on the second information. The image analysis is performed using the application installed on the outdoor unit 20 in step S103.

In step S108, the controller 13 of the information processing apparatus 10 executes a process to notify the user according to at least one of the clothing information for the visitor and the unattended delivery information for the delivery item delivered by the visitor, the clothing information and the unattended delivery information being included in the image acquired in step S104. For example, the controller 13 executes the notification process with respect to at least one of the indoor unit 30 and the terminal apparatus 50 via the communication interface 11 and the network 60.

For example, if the controller 13 detects a delivery company based on the clothing information in the image by the image analysis in step S105, the controller 13 notifies the user that a delivery person of the delivery company is visiting as a visitor. For example, the controller 13 causes the output interface 34 of the indoor unit 30 to output a ringtone, an image of the visitor, or a visual and auditory message indicating that the visitor is a delivery person. For example, the controller 13 causes the output interface 54 of the terminal apparatus 50 to output a ringtone, an image of the visitor, or a visual and auditory message indicating that the visitor is a delivery person.

For example, if the controller 13 detects an unattended delivery based on the unattended delivery information in the image by the image analysis in step S106, the controller 13 notifies the user that a delivery item was placed by unattended delivery. For example, the controller 13 causes the output interface 34 of the indoor unit 30 to output a ringtone, an image of the delivery item that was placed by unattended delivery, or a visual and auditory message indicating that a delivery item was placed by unattended delivery. For example, the controller 13 causes the output interface 54 of the terminal apparatus 50 to output a ringtone, an image of the delivery item that was placed by unattended delivery, or a visual and auditory message indicating that a delivery item was placed by unattended delivery.

For example, if the controller 13 detects the type of delivery item that was placed by unattended delivery based on the unattended delivery information in the image by the image analysis in step S107, the controller 13 notifies the user of the type of delivery item. For example, the controller 13 causes the output interface 34 of the indoor unit 30 to output a predetermined sound, an image of the delivery item that was placed by unattended delivery, or a visual and auditory message indicating the type of delivery item. For example, the controller 13 causes the output interface 54 of the terminal apparatus 50 to output a predetermined sound, an image of the delivery item that was placed by unattended delivery, or a visual and auditory message indicating the type of delivery item.

In the notification process of step S108, the controller 13 may determine the mode of notification according to the content detected by the image analysis prior to step S108. The controller 13 may determine different output modes among visual output and auditory output for each detected content.

For example, the controller 13 may vary the timbre of the ringtone for each type of visitor detected. For example, the controller 13 may cause the ringtone to be outputted with different timbres for a delivery person, a salesman, and an acquaintance. The controller 13 may cause a ringtone with a specific timbre, indicating that a delivery item has been placed by unattended delivery, to be outputted. For example, the controller 13 may vary the timbre of the ringtone for each type of delivery item detected. For example, the controller 13 may cause a predetermined sound to be outputted with different timbres for a cardboard box, a case for delivering books, documents, and the like, and a container covered with thermal sheeting for placing food by unattended delivery.

The plurality of ringtones described above is, for example, pre-installed on the indoor unit 30. The user operates the input interface 33 while checking the display screen of the output interface 34 and sets the corresponding ringtone on the indoor unit 30 for each content detected by the outdoor unit 20. The plurality of ringtones is, for example, similarly pre-installed on the terminal apparatus 50. The user operates the input interface 53 while checking the display screen of the output interface 54 and sets the corresponding ringtone on the terminal apparatus 50 for each content detected by the outdoor unit 20.

In step S109, the controller 13 of the information processing apparatus 10 detects the position of the visitor's face by image analysis based on the image acquired in step S104 and enlarges the region containing the face on the image. The image analysis is performed using the application installed on the outdoor unit 20 in step S103.

In this way, the controller 13 of the information processing apparatus 10 performs various types of image analysis using an application constructed based on machine learning that includes deep learning using a neural network. As described above, the controller 13 may continuously capture images with the imager 21 and perform various types of image analysis under the condition that no operation is being performed on the input interface 22 of the outdoor unit 20 by a visitor or the like. This configuration is not limiting, and the controller 13 may capture images with the imager 21 and perform various types of image analysis in response to a visitor's operation of the input interface 22 in the outdoor unit 20, such as pressing a call button.

In step S110, the controller 13 of the information processing apparatus 10 causes the indoor unit 30 of the intercom system 2 to display the enlarged image in which the region including the visitor's face was enlarged in step S109. For example, the controller 13 executes a display process via the communication interface 11 and the network 60 to cause the output interface 34 of the indoor unit 30 to display the enlarged image.

In step S111, the controller 55 of the terminal apparatus 50 acquires image data newly inputted by the user using the input interface 53. In the present disclosure, the “image data” includes images and the like indicating information on clothing worn by a particular individual that the user desires to be detected by the outdoor unit 20. The controller 55 also acquires information indicating the specific individual, along with the image data, by user input using the input interface 53.

In step S112, the controller 55 of the terminal apparatus 50 transmits the image data acquired in step S111, along with information indicating the specific individual, to the server apparatus 40 via the communication interface 51 and the network 60. The controller 43 of the server apparatus 40 receives the image data and information indicating the specific individual from the terminal apparatus 50 via the network 60 and the communication interface 41.

In step S113, the controller 43 of the server apparatus 40 performs machine learning again as in step S102, using the image data and the information indicating the specific individual acquired in step S112 as training data. The controller 43 updates the application based on the image data and the information indicating the specific individual acquired in step S112.

In step S114, the controller 43 of the server apparatus 40 provides the application updated by the machine learning process in step S113 to the outdoor unit 20 of the intercom system 2. The controller 43 transmits the application to the outdoor unit 20 via the communication interface 41 and the network 60. The controller 13 of the information processing apparatus 10 included in the outdoor unit 20 downloads the updated version of the application from the server apparatus 40 via the network 60 and the communication interface 11 and installs the application.

If, for example, the user has information on a uniform that the user wishes to be detected individually, such as information on the uniform of a particular individual from a food delivery company in the local area, then the user provides such information on the uniform as image data from the user's own terminal apparatus 50 to the server apparatus 40 via the network 60. For example, the server apparatus 40 may provide a web page that accepts uploads of such image data as training data from the user. The server apparatus 40 updates the application through machine learning, based on the image data uploaded from the terminal apparatus 50. The outdoor unit 20 installed in the residence where the aforementioned user resides downloads the updated version of the application from the server apparatus 40 and installs the application.

For example, information on the uniforms of major delivery companies that provide services nationwide is provided in advance to the server apparatus 40 as training data in step S101 and pre-installed on the outdoor unit 20 as an application in step S103. In step S114, information such as uniforms that the user desires to be detected individually is installed on the outdoor unit 20 as additional information.

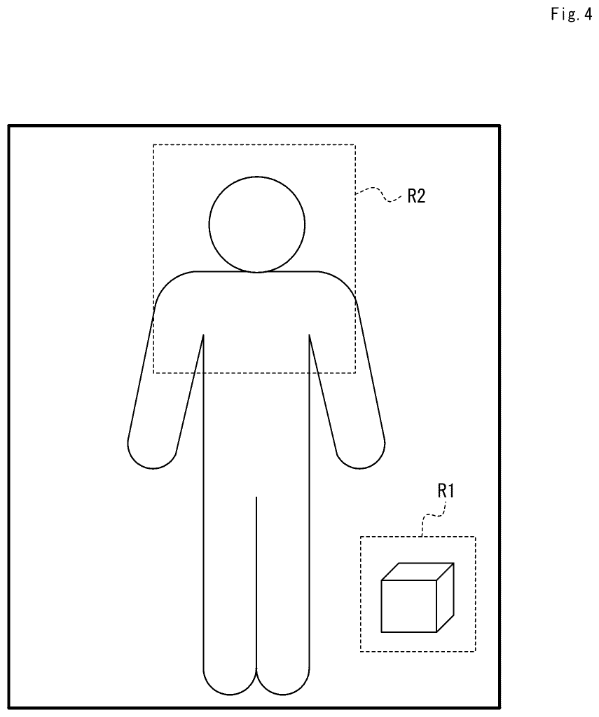

FIG. 4 is a schematic diagram illustrating an example of a process executed by the information processing apparatus 10 in FIG. 2. FIG. 4 illustrates an example of an image captured by the wide-angle camera of the imager 21 included in the outdoor unit 20 of the intercom system 2. The wide-angle camera of the imager 21 is capable of capturing images of the entire body of the visitor by virtue of its wide angle of view. Additionally, the wide-angle camera is capable of capturing images of the ground directly below the outdoor unit 20 by virtue of its wide angle of view. The image illustrated in FIG. 4 includes both clothing information for the visitor and unattended delivery information for the delivery item delivered by the visitor.

The controller 13 of the information processing apparatus 10 executes the process of step S105 in FIG. 3 by image analysis based on information on a full-body uniform of the visitor illustrated in nearly the entire image in FIG. 4. During the image analysis at this time, the controller 13 identifies the position of the full-body image of the visitor in the angle of view, thereby determining the position of the uniform, which has a unique color, shape, and the like, worn by the visitor. The controller 13 recognizes this position of the uniform in the image to detect the uniform and detect the delivery company.

The controller 13 executes the process of step S106 in FIG. 3 by image analysis, since the delivery item is placed on the ground in the region R1 of the image in FIG. 4. At this time, the controller 13 detects the unattended delivery by a predetermined method. The predetermined method includes, for example, a method to analyze a visitor's behavior through image analysis, thereby detecting that the visitor has placed an object on the ground as a delivery item. The predetermined method includes, for example, a method to detect an object of a shape assumed to be an unattended delivery item as a delivery item by image analysis targeting the ground at the entrance where objects are not normally placed.

The controller 13 performs the process of step S107 in FIG. 3 by image analysis based on the appearance of the delivery item contained in the region R1. The controller 13 may display the image illustrated in FIG. 4 as is on at least one of the output interface 34 of the indoor unit 30 and the output interface 54 of the terminal apparatus 50 during the notification process of step S108 in FIG. 3.

On the other hand, for other visitors different from the delivery company delivering the delivery item, the user normally wishes to identify the visitors mainly by their face rather than their whole body. However, if a visitor's whole body is captured by the wide angle of view of the wide-angle camera, it is assumed that the visitor's face displayed on at least one of the output interface 34 of the indoor unit 30 and the output interface 54 of the terminal apparatus 50 will be too small in the image for the user to identify.

Accordingly, in such a case, the controller 13 of the information processing apparatus 10 executes the processes of steps S109 and S110 in FIG. 3. For example, the controller 13 detects the position of the visitor's face by image analysis based on the image illustrated in FIG. 4, enlarges a region R2 containing the face, and causes the region R2 to be displayed on the indoor unit 30 of the intercom system 2. In greater detail, the controller 13 detects the visitor's face as a human face by image analysis and identifies the position of the face within the angle of view. If the position of the face can be identified, the controller 13 enlarges the image to the point that the entire face and the area from the chest up can be seen centered on the position of the face and causes the output interface 34 of the indoor unit 30 to display the enlarged image.

According to the information processing apparatus 10 of the above embodiment, the convenience for the user of the intercom system can be improved. The information processing apparatus 10 executes a process to notify the user according to at least one of clothing information for a visitor and unattended delivery information for a delivery item delivered by the visitor. Therefore, the information processing apparatus 10 can execute processing based on a wider range of information, such as the visitor's clothing and existence of a package placed by unattended delivery, as compared to conventional technology that executes processing based only on the visitor's face. As a result, the information processing apparatus 10 can execute more varied detection processing and the like, as was described using FIG. 3, thereby contributing to improved user convenience.

By acquiring the image captured by the wide-angle camera included in the imager 21 of the outdoor unit 20, the information processing apparatus 10 can execute processing based on an image that has an angle of view including the entire body of the visitor to the ground directly below the outdoor unit 20. Cameras in conventional intercom systems are equipped primarily for the purpose of capturing faces. Therefore, the angle of view of the camera is narrow, causing the range of the captured image to be too small. Consequently, information such as clothing information is not included in the image. For example, conventional cameras generally have an angle of view of 50 to 70 degrees. In contrast, the wide-angle camera included in the imager 21 has a wider angle of view of 120 degrees or more and can capture images with a wide enough range to check the entire body of the visitor and any delivery items placed by unattended delivery.

By detecting a visitor as a delivery person by image analysis based on information on the uniform, the information processing apparatus 10 can distinguish a delivery person of a delivery company from among various visitors and execute a specific notification process. For example, the information processing apparatus 10 can notify the user of a visit by a delivery person of a delivery company with a different ringtone than the standard ringtone, thereby making it easier for the user to distinguish the delivery person from other visitors. The user can easily distinguish between the delivery person of a delivery company and other visitors based on the ringtone. The convenience for the user of the intercom system 2 therefore improves.

By detecting that a delivery item has been placed by unattended delivery by image analysis based on the first information, the information processing apparatus 10 can also distinguish the unattended delivery of a delivery item from a visit by a visitor and can execute a specific notification process. For example, the information processing apparatus 10 can notify the user of the unattended delivery of a delivery item with a different ringtone than the ringtone for a visit by a visitor, thereby making it easier for the user to distinguish the unattended delivery from a visit by a visitor. The ringtone in this case may, for example, be triggered by an autonomous operation of the controller 13 in the information processing apparatus 10 upon detection of the unattended delivery by the information processing apparatus 10, rather than by the visitor pressing a call button. The user can recognize that a delivery item was placed by unattended delivery based on the ringtone. The convenience for the user of the intercom system 2 therefore improves.

By detecting the type of delivery item by image analysis based on the second information, the information processing apparatus 10 can also distinguish the type of delivery item and can execute a specific notification process for each type. For example, the information processing apparatus 10 can notify the user of a delivery item in a cardboard box with a different ringtone than the ringtone for other types of delivery items, thereby making it easier for the user to distinguish the delivery item from other types of delivery items. The user can easily distinguish between a delivery item in a cardboard box and other types of delivery items based on the ringtone. The convenience for the user of the intercom system 2 therefore improves.

The information processing apparatus 10 detects the position of the visitor's face by image analysis based on the image, enlarges the region R2 containing the face, and causes the indoor unit 30 of the intercom system 2 to display the region R2, thereby making it easier for the user to identify the visitor's face. The user can easily identify the visitor's face based on the image displayed on the indoor unit 30. The convenience for the user of the intercom system 2 therefore improves.

By executing the image analysis using an application constructed based on machine learning that includes deep learning using a neural network, the information processing apparatus 10 can more accurately execute various detection processes using image analysis. Therefore, the information processing apparatus 10 can also more accurately execute the notification process following the detection process. The user can receive more accurate notifications from the intercom system 2.

Although the present disclosure is based on embodiments and drawings, it is to be noted that various changes and modifications may be made by those skilled in the art based on the present disclosure. Therefore, such changes and modifications are to be understood as included within the scope of the present disclosure. For example, the functions and the like included in the various configurations and steps may be reordered in any logically consistent way. Furthermore, components or steps may be combined into one or divided.

For example, a general purpose electronic device, such as a smartphone or a computer, can also be caused to function as the information processing apparatus 10 according to the above embodiment. Specifically, a program describing the processing content for realizing the functions of the information processing apparatus 10 according to an embodiment is stored in a memory of the electronic device, and the program is read and executed by the processor of the electronic device. Accordingly, the present disclosure can also be embodied as a program executable by a processor.

Alternatively, the present disclosure can also be realized as a non-transitory computer readable medium storing a program executable by one or more processors to cause the information processing apparatus 10 or the like according to an embodiment to execute each function. Such embodiments are also to be understood as falling within the scope of the present disclosure.

For example, at least a portion of the processing operations executed by the information processing apparatus 10 in the above embodiment may be executed by the server apparatus 40 or the indoor unit 30. For example, the information processing apparatus 10 may be configured as the server apparatus 40 itself, rather than being provided in the outdoor unit 20. In this case, the outdoor unit 20 may be communicably connected to the information processing apparatus 10 as the server apparatus 40, rather than including the information processing apparatus 10 therein.

Conversely, at least a portion of the processing operations executed by the server apparatus 40 may be executed by the information processing apparatus 10 included in the outdoor unit 20. For example, the processing operations related to machine learning that were executed on the server apparatus 40 may be executed on the information processing apparatus 10.

In the above embodiment, the information processing apparatus 10 has been described as acquiring an image captured by a wide-angle camera, included in the imager 21, having an angle of view including the entire body of the visitor to the ground directly below the outdoor unit 20, but this configuration is not limiting. The imager 21 may include another camera with an angle of view smaller than 120 degrees, for example, instead of the wide-angle camera, as long as the image can include at least one of the clothing information for the visitor and the unattended delivery information for the delivery item delivered by the visitor. In this case, the imager 21 may be configured to freely change the image capturing range by changing the vertical orientation of the other camera.

The information processing apparatus 10 may detect a delivery slip, contained in an image, by image analysis. The information processing apparatus 10 may read the name of the item or other information on the slip by character recognition to acquire information about the content of the delivery item. The information processing apparatus 10 may include the acquired information about the content in the notification process.

In the above embodiment, the information processing apparatus 10 has been described as detecting the visitor as a delivery person by image analysis based on the information on the uniform, but this configuration is not limiting. Instead of executing such a detection process, the information processing apparatus 10 may directly execute a process to notify the user according to the information on the visitor's uniform included in the acquired image.

In the above embodiment, the information processing apparatus 10 has been described as detecting that a delivery item was placed by unattended delivery by image analysis based on the first information, but this configuration is not limiting. Instead of executing such a detection process, the information processing apparatus 10 may directly execute a process to notify the user according to the first information included in the acquired image.

In the above embodiment, the information processing apparatus 10 has been described as detecting the type of delivery by image analysis based on the second information, but this configuration is not limiting. Instead of executing such a detection process, the information processing apparatus 10 may directly execute a process to notify the user according to the second information included in the acquired image.

In addition to or instead of the specific examples of the notification process described in the above embodiment, the information processing apparatus 10 may execute the notification process in any other manner. For example, the information processing apparatus 10 may execute the notification process only for a specific visitor, such as a delivery person of a delivery company, and may refrain from executing the notification process for other visitors. For example, the information processing apparatus 10 may execute the notification process related to unattended delivery only with respect to the terminal apparatus 50, and not the indoor unit 30.

In the above embodiment, notification has been described as unilaterally being provided to the user from the outdoor unit 20 in the information processing system 1, but this configuration is not limiting. For example, in a case in which the information processing apparatus 10 executes a notification process with respect to the terminal apparatus 50 only for a delivery person of a delivery company, the information processing system 1 may enable two-way communication between the user and the delivery person via the terminal apparatus 50, the network 60, and the outdoor unit 20. Since the visitor is limited to being a delivery person when the notification process is performed on the user's terminal apparatus 50, the user can have some grasp of the situation upon receiving the notification before starting to communicate with the delivery person. This enables the user to start communicating smoothly.

In the above embodiment, the information processing apparatus 10 has been described as detecting the position of the visitor's face by image analysis based on the image, enlarging the region R2 containing the face, and causing the indoor unit 30 of the intercom system 2 to display the region R2, but this configuration is not limiting. The information processing apparatus 10 need not execute such processing.

In the above embodiment, the information processing apparatus 10 has been described as executing the image analysis using an application constructed based on machine learning that includes deep learning using a neural network, but this configuration is not limiting. The application may be constructed based on machine learning using other methods, such as a support vector machine and a random forest.

In addition to the processes described in the above embodiment, the information processing apparatus 10 may register a delivery company for which the date and time of a visit has been specified in advance, and when a visitor arrives, may distinguish whether the visit is the scheduled visit by the delivery company or is some other unscheduled visit. The information processing apparatus 10 may execute the notification process according to the distinguished result.

In addition to the processes described in the above embodiment, the information processing apparatus 10 may register in advance the date and time of unattended delivery, and when a delivery item is placed by unattended delivery, may distinguish whether the scheduled delivery item was placed by unattended delivery, or whether another unscheduled delivery item was placed by unattended delivery. The information processing apparatus 10 may execute the notification process according to the distinguished result.

In addition to the processes described in the above embodiment, the information processing apparatus 10 may also use an application to realize a function of face recognition for images captured by the imager 21 and may specifically detect the identity of the visitor.

Some embodiments of the present disclosure are exemplified below. It should be noted that the embodiments of the present disclosure are not, however, limited to these examples.

[Appendix 1] An information processing apparatus comprising: a controller configured to acquire an image captured using an imager included in an outdoor unit of an intercom system and execute a process to notify a user according to at least one of clothing information, included in the acquired image, for a visitor and unattended delivery information, included in the acquired image, for a delivery item delivered by the visitor.

[Appendix 2] The information processing apparatus according to appendix 1, wherein the image acquired by the controller is captured by a wide-angle camera, included in the imager, having an angle of view including an entire body of the visitor to a ground directly below the outdoor unit.

[Appendix 3] The information processing apparatus according to appendix 2, wherein the clothing information includes information on a full-body uniform worn by the visitor as a delivery person of a delivery company, and
the controller is configured to detect the visitor as the delivery person by image analysis based on information on the uniform.

[Appendix 4] The information processing apparatus according to appendix 2 or 3, wherein
the unattended delivery information includes placement of the delivery item on the ground as first information, and
the controller is configured to detect that the delivery item has been placed by unattended delivery by image analysis based on the first information.

[Appendix 5] The information processing apparatus according to any one of appendices 2 to 4, wherein
the unattended delivery information includes an appearance of the delivery item placed on the ground as second information, and
the controller is configured to detect a type of the delivery item by image analysis based on the second information.

[Appendix 6] The information processing apparatus according to any one of appendices 2 to 5, wherein the controller is configured to detect a position of a face of the visitor by image analysis based on the image, enlarge a region containing the face, and cause an indoor unit of the intercom system to display the region.

[Appendix 7] The information processing apparatus according to any one of appendices 3 to 6, wherein the controller is configured to execute the image analysis using an application constructed based on machine learning that includes deep learning using a neural network.

[Appendix 8] An outdoor unit of an intercom system, the outdoor unit comprising the information processing apparatus according to any one of appendices 1 to 7.

[Appendix 9] An information processing method comprising:
acquiring an image captured using an imager included in an outdoor unit of an intercom system; and
executing a process to notify a user according to at least one of clothing information, included in the acquired image, for a visitor and unattended delivery information, included in the acquired image, for a delivery item delivered by the visitor.

[Appendix 10] A program configured to cause an information processing apparatus to execute operations comprising:
acquiring an image captured using an imager included in an outdoor unit of an intercom system; and
executing a process to notify a user according to at least one of clothing information, included in the acquired image, for a visitor and unattended delivery information, included in the acquired image, for a delivery item delivered by the visitor.

### INDUSTRIAL APPLICABILITY

1 Information processing system
2 Intercom system
10 Information processing apparatus
11 Communication interface
12 Memory
13 Controller
20 Outdoor unit
21 Imager
22 Input interface
23 Output interface
30 Indoor unit
31 Communication interface
32 Memory
33 Input interface
34 Output interface
35 Controller
40 Server apparatus
41 Communication interface
42 Memory
43 Controller
50 Terminal apparatus
51 Communication interface
52 Memory
53 Input interface
54 Output interface
55 Controller
60 Network
R1 Region
R2 Region

1: An information processing apparatus comprising:
a controller configured to acquire an image captured using an imager included in an outdoor unit of an intercom system and execute a process to notify a user according to at least one of clothing information, included in the acquired image, for a visitor and unattended delivery information, included in the acquired image, for a delivery item delivered by the visitor.

2: The information processing apparatus according to claim 1, wherein the image acquired by the controller is captured by a wide-angle camera, included in the imager, having an angle of view including an entire body of the visitor to a ground directly below the outdoor unit.

3: The information processing apparatus according to claim 2, wherein
the clothing information includes information on a full-body uniform worn by the visitor as a delivery person of a delivery company, and
the controller is configured to detect the visitor as the delivery person by image analysis based on information on the uniform.

4: The information processing apparatus according to claim 2, wherein
the unattended delivery information includes placement of the delivery item on the ground as first information, and
the controller is configured to detect that the delivery item has been placed by unattended delivery by image analysis based on the first information.

5: The information processing apparatus according to claim 2, wherein
the unattended delivery information includes an appearance of the delivery item placed on the ground as second information, and
the controller is configured to detect a type of the delivery item by image analysis based on the second information.

6: The information processing apparatus according to claim 2, wherein the controller is configured to detect a position of a face of the visitor by image analysis based on the image, enlarge a region containing the face, and cause an indoor unit of the intercom system to display the region.

7: The information processing apparatus according to claim 3, wherein the controller is configured to execute the image analysis using an application constructed based on machine learning that includes deep learning using a neural network.

8: An outdoor unit of an intercom system, the outdoor unit comprising the information processing apparatus according to claim 1.

9: An information processing method comprising:
acquiring an image captured using an imager included in an outdoor unit of an intercom system; and
executing a process to notify a user according to at least one of clothing information, included in the acquired image, for a visitor and unattended delivery information, included in the acquired image, for a delivery item delivered by the visitor.

10: A non-transitory computer readable medium storing a program executable by one or more processors configured to cause an information processing apparatus to execute operations comprising:
acquiring an image captured using an imager included in an outdoor unit of an intercom system; and
executing a process to notify a user according to at least one of clothing information, included in the acquired image, for a visitor and unattended delivery information, included in the acquired image, for a delivery item delivered by the visitor.
